(19) United States
(12) Patent Application Publication
(10) Pub. No.: US 2013/0151902 A1
(43) Pub. Date: Jun. 13, 2013

(54) DEBUG SYSTEM AND METHOD

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/559,543

(22) Filed: Jul. 26, 2012

(30) Foreign Application Priority Data
Dec. 12, 2011 (CN) 201110411719.0

(51) Int. Cl. G06F 11/28

(52) U.S. Cl. 714/30; 714/E11.178

(57) ABSTRACT

A debug system includes a debug device and a computer. The debug device includes an IIC reading and writing module, a first control module; and a signal receiving and transmitting module. The computer includes a second control module. The IIC reading and writing module is connected to an IIC device. The second control module sends an inputted command to the first control module via the signal receiving and transmitting module. The first control module reads data from the IIC device or writes data to the IIC device via the IIC reading and writing module according to the inputted command

### BACKGROUND

1. Technical Field

The present disclosure relates to debug systems and methods, and more particularly to a debug system and a method based on an Inter-Integrated Circuit (IIC) bus.

2. Description of Related Art

The traditional debugging method is analyzing data from the IIC bus via an oscillograph or logic analyzer. However, it is inconvenient being connected to a peripheral device to input commands to read or write data.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a debug system.

FIG. 2 is flowchart of one embodiment of a reading data method of a debug method.

FIG. 3 is flowchart of one embodiment of a writing data method of a debug method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

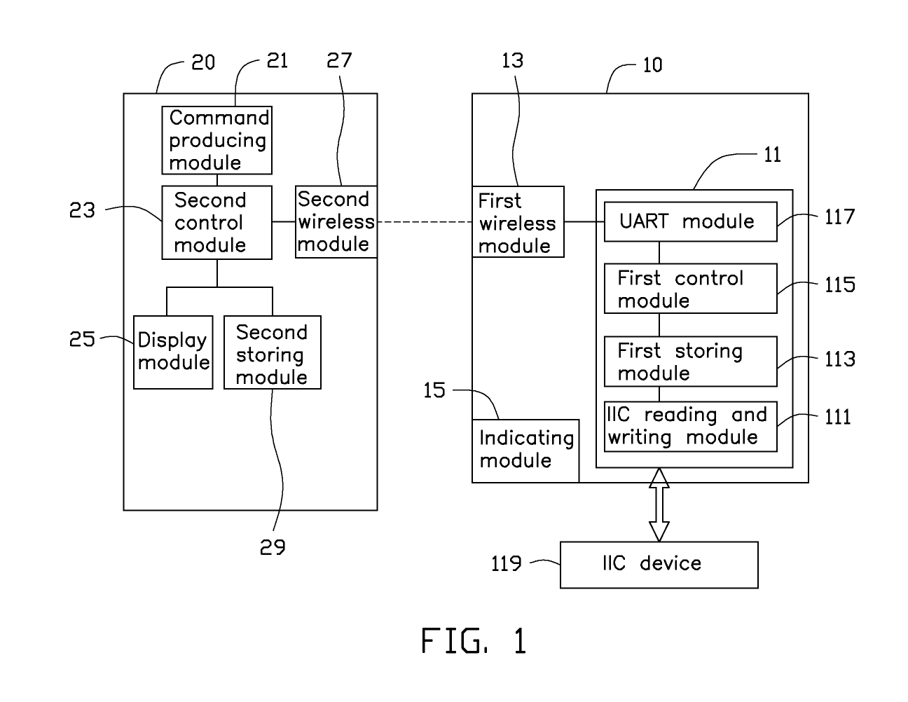

Referring to FIG. 1, a debug system according to one embodiment includes a debug device 10 and a computer 20.

The debug device 10 includes a control chip 11, a first wireless module 13 connected to the control chip 11, and an indicator module 15 connected to the control chip 11. In one embodiment, the control chip 11 is a micro control unit (MCU), the first wireless module 13 is a PRT200 IC chip. The indicator module 15 is a light-emitting diode (LED). The indicator module 15 indicates the work status of the control chip 11.

The control chip 11 includes an IIC reading and writing module 111, a first storing module 113, a first control module 115, and a signal receiving and sending module. In one embodiment, the signal receiving and sending module is a universal asynchronous receiver and transmitter (UART) module 117. The first storing module 113 is a dual port random access memory (DPRAM). The IIC reading and writing module 111 is connected to an IIC device 119, such as a temperature sensor. The IIC reading and writing module 111 is used for reading data from the IIC device 119 and stores the data to the first storing module 113.

The computer 20 includes a command producing module 21, a second control module 23, a display module 25, a second wireless module 27, and a second storing module 29. In one embodiment, the second control module 23 is a central processing unit (CPU). The display module 25 is liquid crystal display (LCD). The second storing module 29 is a hard disk drive. There are wireless signals transmitted between the second wireless module 27 and the first wireless module 13. The user can input a read or write command to the command producing module 21 via an input device, such as a keyboard.

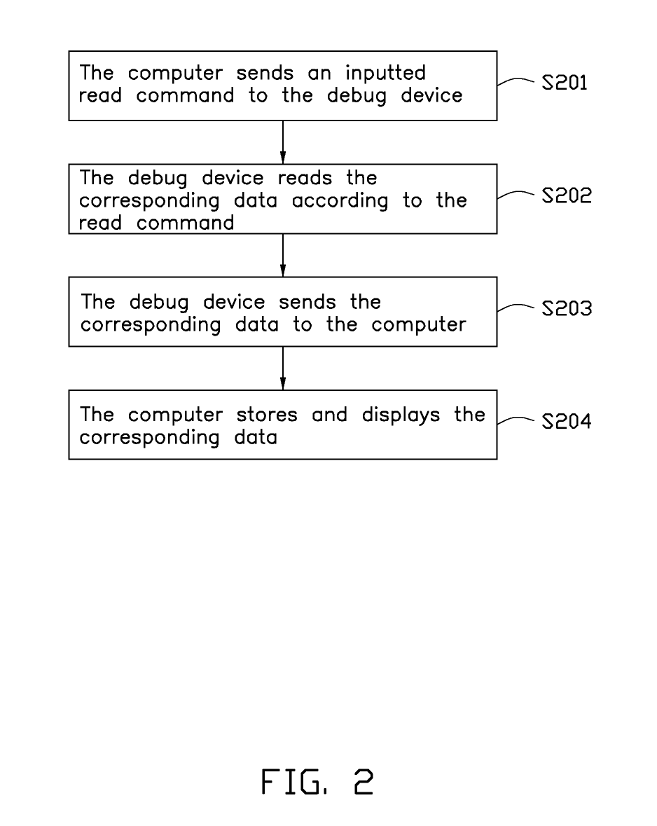

Referring to FIGS. 1 and 2, a reading data method of a debug method according to one embodiment is shown in the following steps (Ss).

S201, the computer 20 sends an inputted read command to the first wireless module 13 via the second wireless module 27. The first wireless module 13 transmits the read command to the first control module 115 via the UART module 117.

S202, the first control module 115 of the debug device 10 reads data corresponding to the read command from the first storing module 113. In one embodiment, the IIC reading and writing module 111 sends a finished signal to the first control module 115 after reading the data from the IIC device 119. The first control module 115 reads the data corresponding to the read command from the first storing module 113 after receiving the finished signal.

S203, the first control module 115 of the debug device 10 sends the data to the second wireless module 27 via the UART module 117 and the first wireless module 13. The second wireless module 27 transmits the data to the second control module 23 of the computer 20.

S204, the second control module 23 of the computer 20 stores the data to the second storing module 29 and displays the data on the display module 25.

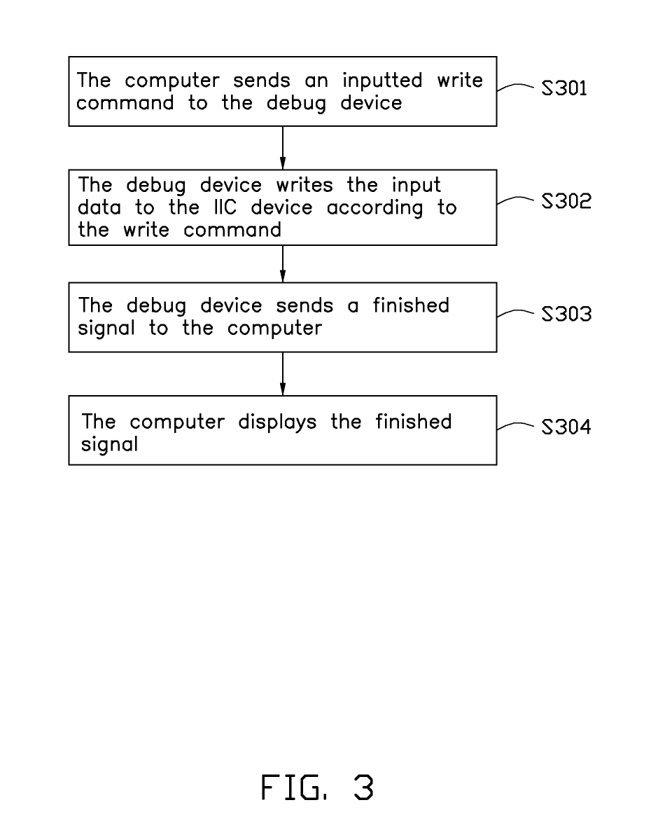

Referring to FIGS. 1 and 3, a writing data method of a debug method according to one embodiment is shown in the following steps.

S301, the computer 20 sends a write command to the first wireless module 13 via the second wireless module 27. The first wireless module 13 transmits the write command to the first control module 115 via the UART module 117.

S302, the first control module 115 of the debug device 10 writes input data of the write command to the IIC device 119 via the IIC reading and writing module 111.

S303, the IIC reading and writing module 111 sends a finished signal to the first control module 115 after writing the input data to the IIC device 119. The first control module 115 sends the finished signal to the second control module 23 via the UART module 117, the first wireless module 13 and the second wireless module 27.

S304, the second control module 23 displays the finished signal on the display module 25.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A debug system comprising:
a debug device, the debug device comprising:
an IIC reading and writing module, the IIC reading and writing module configured to be connected to an IIC device;
a first control module; and
a signal receiving and transmitting module; and
a computer, the computer comprising a second control module;
wherein the second control module is configured to send an inputted command to the first control module via the signal receiving and transmitting module, and the first control module is configured to, according to the inputted command, read data from the IIC device or write data to the IIC device via the IIC reading and writing module.

2. The debug system of claim 1, wherein the debug device further comprises a first storing module; the computer further comprise a second storing module and a display module; the inputted command is read command; the IIC reading and writing module is configured to read data from the IIC device and stores the data to the first storing module; the first control module is configured to send the data to the second control module via the signal receiving and transmitting module; and the second control module is configured to store the data to the second storing module and display the data on the display module.

3. The debug system of claim 2, wherein the IIC reading and writing module is configured to send a finished signal to the first control module after reading the data from the IIC device, and the first control module is configured to obtain the data after receiving the finished signal.

4. The debug system of claim 1, wherein the inputted command is a write command; the write command comprises a writing code, an IIC address corresponding to the IIC device, and a writing data; and the first control module is configured to write the writing data to the IIC device.

5. The debug system of claim 4, wherein the computer further comprises a display module; the IIC reading and writing module is configured to send a finished signal to the first control module after writing the writing data to the IIC device; the first control module is configured to send the finished signal to the second control module via the signal receiving and transmitting module; and the second control module is configured to display the finished signal on the display module.

6. The debug system of claim 1, wherein the debug device further comprises a first wireless module connected to the signal receiving and transmitting module; the computer further comprises a second wireless module connected to the second control module; and the inputted command is configured to be transmitted to the first control module via the signal receiving and transmitting module, the first wireless module, and the second wireless module.

7. A debug method comprising:
inputting a read command to a debug device via a computer;
reading data from an IIC device connected to the debug device via the debug device and storing the data;
sending the data to the computer via the debug device; and
storing and displaying the data via the computer.

8. The debug method of claim 7, wherein the data is transmitted from the debug device to the computer via a wireless manner.

9. The debug method of claim 7, wherein the data is read by a MCU of the debug device.

10. The debug method of claim 9, further comprising indicating a work status of the MCU via an LED.
